(19) United States
(12) Patent Application Publication
(10) Pub. No.: US 2008/0106047 A1
(43) Pub. Date: May 8, 2008

(54) Drill bit pipe clamp/ end cap drill bit

(76) Inventor: Wayne Harvey Snyder, Simi Valley, CA (US)

Correspondence Address: Wayne Snyder, 699 Appleton Rd, Simi Valley, CA, 93065, US

(21) Appl. No.: 11/593,413

(22) Filed: Nov. 6, 2006

(51) Int. Cl. B23B 5/22; B26F 1/20; B65D 59/00

(52) U.S. Cl. 279/133; 83/867; 138/96 R

(57) ABSTRACT

An apparatus to facilitate the boring of holes through obstructions when installing pipes.

A clamp that fixes a drill bit or boring tool centered on the end of a pipe, conduit or rod such that when the pipe, conduit or rod is rotated about the longitudinal axis the clamp transfers the rotational and longitudinal forces to the drill bit or boring tool which in turn rotates about it's longitudinal axis. An end cap for a pipe, conduit or rod that has a drill bit or boring tool incorporated such that when the End Cap Drill Bit is installed on a pipe, conduit or rod and the pipe, conduit or rod is rotated about it's longitudinal axis the End Cap Drill Bit will cut a hole in obstructions that the End Cap Drill Bit is pushed against. And a diameter reducing tool that can be fixed to the opposite end of the pipe, conduit or rod, as required, so that a drill can be attached.

### BACKGROUND OF INVENTION

This invention relates in general to boring tools and extensions to drill bits having particular application for plumbing, natural gas pipes and electrical installations as well as other more general drilling uses.

As those in the construction industry and building trades are well aware, a considerable amount of rough boring of framing, roofs, floors and ceilings is required to permit installation of plumbing pipes, natural gas pipes and electrical wiring conduits. Often long lengths of pipe and conduit are installed. This requires many holes to be bored in a straight line before the pipes and/or conduits can be installed.

Prior art requires that a worker move from frame, roof, floor or ceiling member to frame, roof, floor or ceiling member, locate and bore a hole in each one, then move to the next one. Once all the holes are bored then the pipe or conduit is pushed through and guided as often the holes do not line up perfectly. Alternately and in special circumstances where the worker cannot reach the frame, roof, floor or ceiling member to bore the hole, extensions are used to extend the reach of the drill bit. This requires that tradesmen carry various lengths of extensions so they have the one they need that is long enough but not too long. Once the hole is cut then the drill bit or boring tool and extensions are removed and then the pipe or conduit is installed.

This invention can save labor and eliminate the need to have extension tools available;

To save labor the Drill Bit Pipe Clamp is fixed on the end of the pipe or conduit to be installed and a drill bit or boring tool is secured in the clamping tool. The diameter reducing tool is fixed to the other end of the pipe, conduit or rod, as required. The dill is clamped to the pipe, conduit or rod or diameter reducing tool, as required, and the pipe or conduit is rotated and pushed through the frame, roof, floor or ceiling member as the tool on the end of the pipe or conduit bores the hole. If multiple lengths of pipe are required then after one length is pushed through as many frames, roofs, floors or ceiling members as it's length allows, the diameter reducing tool is removed, the next length of pipe or conduit is connected, the diameter reducing tool and drill are installed on the end of that pipe or conduit and all the lengths of pipe or conduit are rotated and pushed into place. Once the pipe or conduit is in place then the clamping tool and diameter reducing tool are removed and the standard fittings can be installed on the pipe or conduit.

With this tool tradesmen can use the very pipe or conduit they are installing as extensions to their drill bits and boring tools. This will save them money and the transporting of many tools.

### DETAILED DESCRIPTION

The Drill Bit Pipe Clamp clamps to a drill bit or boring tool on one end and a pipe or conduit on the other end. Thus a structure with two cylindrical sections aligned on a common longitudinal axis is a logical form for this tool.

One cylindrical section, generally the smaller, would generally have a hole in it's center along the longitudinal axis that would be a close fit for the shaft of a drill bit or boring tool. This section would have a method to secure the drill bit or boring tool in place and prevent the drill bit or boring tool from falling out. This could be a screw that tightens against the shaft of the drill bit or other means. It would use this feature or another method, such as a hexagonal or D shaped hole to prevent the drill bit or boring tool from rotating with respect to the Drill Bit/Pipe Clamp. Other methods, such as a drill bit chuck, could be used to secure the drill bit or boring tool.

The other cylindrical section, generally the larger, would generally have a hole in it's center along the longitudinal axis that would be a close fit for the pipe or conduit. This section would have a method to secure the DRILL BIT PIPE CLAMP in place and prevent the DRILL BIT PIPE CLAMP from falling off the pipe or conduit. One method of securing the DRILL BIT PIPE CLAMP in place would be a pipe thread that mates with a pipe thread on the end of the pipe, conduit or rod. Other methods, such as a screw that tightens against the pipe, conduit or rod or mechanisms that reduce the inside diameter of this section of the tool could be some of the methods to secure the DRILL BIT PIPE CLAMP in place on the pipe, conduit or rod. It would use this feature or another method to prevent the DRILL BIT PIPE CLAMP from rotating with respect to the pipe or conduit.

The End Cap Drill Bit is fixed to a pipe, conduit or rod such that when the pipe, conduit or rod is rotated about it's longitudinal axis the End Cap Drill Bit bores a hole in any frame, roof, floor or ceiling member that the End Cap Drill Bit is pushed against.

Drill bit and boring tool technology is already well known. End caps are also a well know technology. This invention combines the two technologies into a single device that saves time and money.

### BRIEF DESCRIPTION OF DRAWINGS

FIG. 1: Shows the preferred embodiment of the Drill Bit Pipe Clamp where;

Item 1 is the smaller cylindrical section that is used to clamp the Drill bit or boring tool. In this figure this the outside surface of the smaller cylindrical section has a hexagonal shape to facilitate the installation of the DRILL BIT PIPE CLAMP onto the threaded end of a pipe.

Item 2 is the hole where the drill bit or boring tool shaft is to be inserted.

Item 3 is a threaded hole and a screw that can be tightened against the shaft of the drill bit or boring tool to secure it in place.

Item 4 is the larger cylindrical section that fits over the pipe, conduit or rod.

FIG. 2 Shows another view of the preferred embodiment where;

Item 4 is, again, the larger cylindrical section that fits over the pipe, conduit or rod.

Item 5 is a hole with a female pipe thread that can secure the DRILL BIT PIPE CLAMP to a pipe, conduit or rod.

FIG. 3 is a side view of the DRILL BIT/PIPE CLAMP

FIGS. 4, 5, 6 Show the diameter reducing tool from various perspectives.

FIG. 7: Shows the preferred embodiment of the End Cap Drill Bit where;

Item 1 is a hole with a female pipe thread that can secure the END CAP DRILL BIT to a pipe, conduit or rod.

Item 2 is the cylindrical section of the end cap.

Item 3 is the drill bit portion of the End Cap Drill Bit.

FIG. 8 Shows another view of the preferred embodiment where;

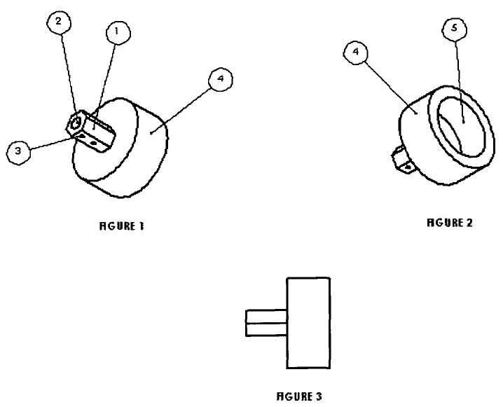

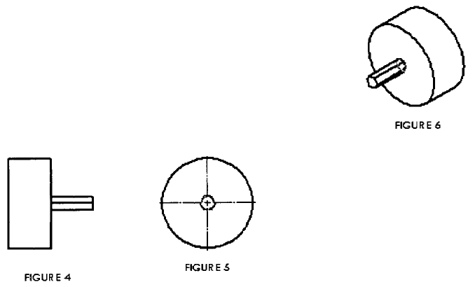

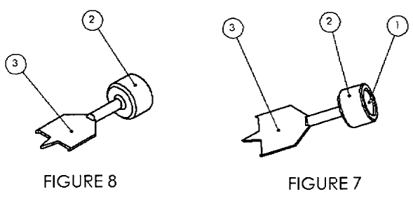

Item 2 is, again, the cylindrical section of the end cap.

Item 3 is the drill bit portion of the End Cap Drill Bit

What is claimed is:

1. A clamping tool, comprising:
a. a means to secure a drill bit or boring tool, generally, centered on the longitudinal axis of the clamping tool with the longitudinal axis of the drill bit or boring tool, generally, in line with the longitudinal axis of the clamping tool,
b. a means to secure the clamping tool, generally, centered on the longitudinal axis of a pipe, conduit or rod with the longitudinal axis of the clamping tool, generally, in line with the longitudinal axis of the pipe, conduit or rod,
c. a means for securing said drill bit or boring tool, against rotation relative to the clamping tool,
d. a means to secure the clamping tool, against rotation relative to the pipe, conduit or rod.

2. A diameter reducing tool, comprising,
a. a generally cylindrical body with a reduced diameter shaft, generally, centered on the longitudinal axis of the diameter reducing tool with the longitudinal axis of the reduced diameter shaft, generally, in line with the longitudinal axis of the diameter reducing tool,
b. a means to secure the diameter reducing tool, generally, centered on the longitudinal axis of a pipe, conduit or rod with the longitudinal axis of the clamping tool, generally, in line with the longitudinal axis of the pipe, conduit or rod,
c. a means to secure the diameter reducing tool, against rotation relative to the pipe, conduit or rod.

3. An end cap for a pipe, conduit or rod with an integrated drill bit or boring tool, comprising:
a. a means to secure the end cap drill bit on a pipe, conduit or rod,
b. a drill bit or boring tool that will, when rotated, cut a hole through obstructions, such as frame, roof, floor or ceiling member, that it is pushed against.
